(19) United States
(12) Patent Application Publication
(10) Pub. No.: US 2010/0166381 A1
(43) Pub. Date: Jul. 1, 2010

(54) VIDEO PLAYBACK APPARATUS AND VIDEO PLAYBACK METHOD

(75) Inventor: Kazuaki TAKEUCHI, Ome-shi (JP)

Correspondence Address: MCDERMOTT WILL & EMERY LLP, 18191 VON KARMAN AVE., SUITE 500, IRVINE, CA, 92612-7108, US

(73) Assignee: KABUSHIKI KAISHA TOSHIBA, Tokyo (JP)

(21) Appl. No.: 12/645,408

(22) Filed: Dec. 22, 2009

(30) Foreign Application Priority Data
Dec. 26, 2008 (JP) 2008-334643

(51) Int. Cl. H04N 5/91; H04N 5/93

(52) U.S. Cl. 386/52; 386/95; 386/E05.003

(57) ABSTRACT

According to one embodiment, a video apparatus comprises a program recorder configured to record programs divided into scenes, a program information recorder configured to record program information includes scene information of each scene of the recorded program, a module configured to examine relevance of scenes among the recorded programs based on the recorded scene information in order to set priorities to relevant scenes among the recorded programs, an instruction module configured to instruct playback of any one of the recorded programs, and a playback module configured to play back a scene with a highest priority among scenes relevant to a certain scene of a program of which playback is instructed.

### CROSS-REFERENCE TO RELATED APPLICATIONS

This application is based upon and claims the benefit of priority from Japanese Patent Application No. 2008-334643, filed Dec. 26, 2008, the entire contents of which are incorporated herein by reference.

### BACKGROUND

1. Field

One embodiment of the invention relates to a video playback apparatus and a video playback method for playing back a digest of stored videos.

2. Description of the Related Art

According to a conventional video playback apparatus and a video playback method, a digest is created from a content including media data such as a moving picture image, a still picture image, text, and sound, and playback timing data of the media data (See Japanese Patent KOKAI Publication No. 2000-235652).

This document describes a case where Synchronized Multimedia Integration Language (SMIL) is used as data describing a relationship in time among a plurality of items of media data, and Hypertext Markup Language (HTML) is used as a format of the digest. The SMIL data describes locations and playback timings of the media data being used. The HTML data includes a digest of text, and a link to digest image data of moving and still picture image data. A playback time relationship between the different items of media data is analyzed from the playback timing data, scene division is performed using a playback start time and a playback end time of each item of media data, importance of the scene to be obtained is calculated from importance of each item of media data, and digest data from each item of media data is constructed. Thus, from a content including SMIL data and a plurality of items of media data, image data and an HTML file, which become a digest of the media data, are created.

The apparatus of the above-described document, however, creates a digest for each content by processing contents each including a plurality of items of media data, and does not compile a plurality of contents into one digest. Relevant contents may be effectively viewed when compiled into one digest, but the above-described document cannot handle such a situation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view illustrating a configuration of a video playback apparatus according to a first embodiment of the present invention.

FIG. 2 is an exemplary view illustrating descriptions of a program recording module and a program information recording module according to the first embodiment of the present invention.

FIG. 3 is an exemplary flowchart illustrating a playback operation according to the first embodiment of the present invention.

FIG. 4 is an exemplary flowchart illustrating details of program association in FIG. 3.

FIG. 5 is an exemplary flowchart illustrating details of scene association in FIG. 3.

FIG. 6 is an exemplary view illustrating a principle of digest playback.

FIG. 7 is an exemplary flowchart illustrating details of digest playback in FIG. 3.

FIG. 8 is an exemplary view illustrating an example of a scene association list in which priorities are assigned.

### DETAILED DESCRIPTION

Various embodiments according to the invention will be described hereinafter with reference to the accompanying drawings. In general, according to one embodiment of the invention, a video playback apparatus comprises a program recorder configured to record programs each divided into scenes; a program information recorder configured to record program information comprising scene information of each scene of a program recorded by the program recorder; a priority setting module configured to examine relevance of scenes among the programs recorded by the program recorder based on the scene information recorded by the program information recorder in order to set priorities to relevant scenes among the programs recorded by the program recorder; a playback instruction module configured to instruct playback of any one of the programs recorded by the program recorder; and a playback module configured to play back a scene with a highest priority among scenes relevant to a certain scene of a program of which playback is instructed.

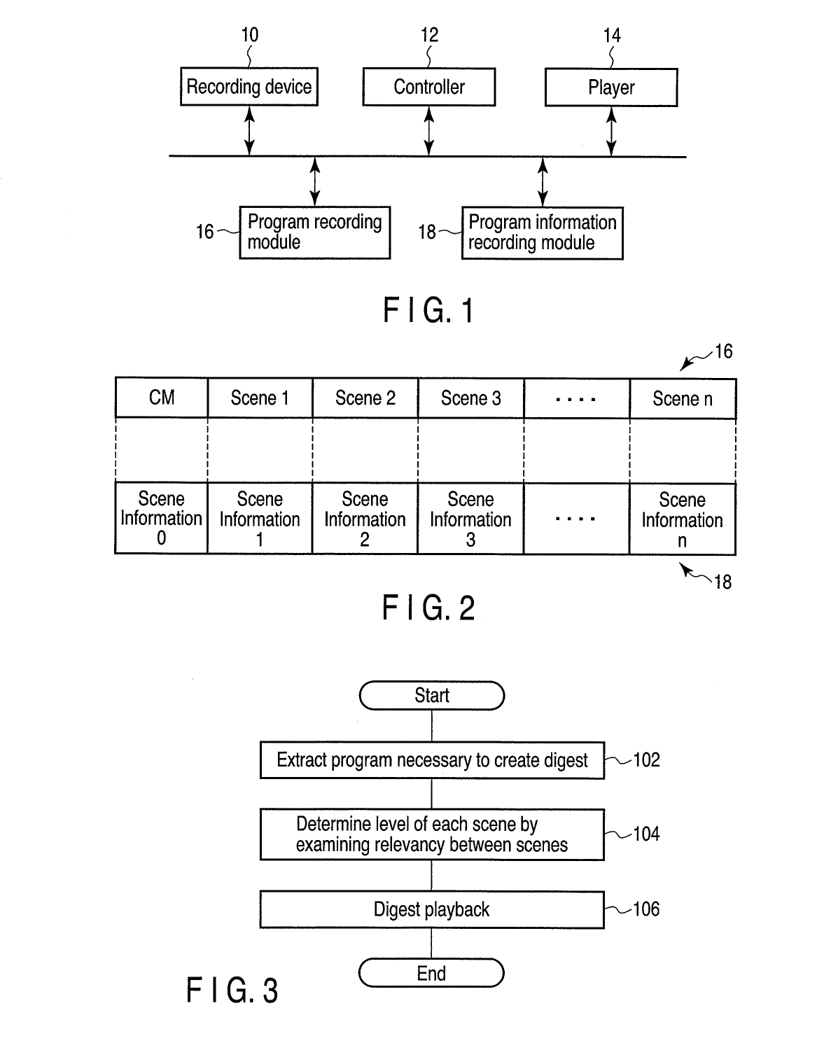

FIG. 1 illustrates a configuration of a video playback apparatus according to a first embodiment of the present invention. A content (or a program) received by a tuner, not shown, or a program downloaded through the Internet via a network interface is processed by a recording device 10, and the program itself is recorded in a program recording module 16, and information indicating descriptions of the program is recorded in a program information recording module 18. The recording modules 16, 18 may be the same recording device (a hard disc drive, for example), or may be separate recording devices. In the case of separate recording devices, since program information is not very big in size, the program information recording module 18 may be formed of a semiconductor memory to which high-speed access can be made. The program recording module 16 store a plurality of programs, which may also be recorded in separate recording modules.

The program information is formed of scene information characterizing each scene (a unit in which a program is subdivided) of a program recorded in the program recording module 16. The program may be divided beforehand into scenes in a broadcasting station, may be divided when the recording device 10 records a program in the program recording module 16, or may be read once after being recorded in the program recording module 16, divided into scenes, and recorded again. The scene division may be performed automatically at a predetermined time, or may be performed adaptively by a broadcasting station and the recording device 10 based on change in waveform of images, sound and music data. When a program is divided into scenes by a broadcasting station, scene information provided by the broadcasting station in association with the division is used as the program information. The scene information includes, for example, a program title, a genre, characters, a case title (in the case of news), and a broadcast time. Furthermore, as the program information, metadata provided by the broadcasting station may be used without modification, or a text into which waveforms of images, sound, music data, and so forth characterizing the scene are converted, when the recording device 10 analyzes a program and divides it into scenes, may be used. Furthermore, the recording device 10 may analyze metadata provided by the broadcasting station and extract a program title, a genre, characters, a case title (in the case of news).

The player 14 is a part which plays back data in the program recording module 16, and uses information in the program information recording module 18 to obtain a playback position.

The controller 12 is a part which controls the whole video playback apparatus, and detects similarity among scenes of different programs based on information of the program information recording module 18 recorded by the recording device 10, performs an operation to associate the programs, and performs digest playback.

FIG. 2 shows relationship of data recorded in the program recording module 16 and the program information recording module 18. For example, the program in the program recording module 16 is configured such that a commercial is placed at the beginning, and then Scene 1 to Scene n are placed. The division of the scenes may be performed based on the degree of similarity among the frames, information obtained by speech recognition, and metadata associated with the program, for example. For each of the scenes including the commercial, Scene Information 0 to Scene Information n are created and recorded in the program information recording module 18. Although not shown, in the program information recording module 18, one item of program information, as well as the scene information, is recorded for every program. The program information includes a program title, a genre, characters, a case title, and so forth, as in the case of the scene information.

FIG. 3 is a flowchart illustrating a process in which the video playback apparatus performs digest playback according to the first embodiment. FIG. 3 includes a digest playback block 106 and preprocessing blocks 102 and 104 for preparation for the digest playback. The preprocessing blocks 102, 104 may be automatically performed after recording of the program, or may be begun by an instruction for digest playback.

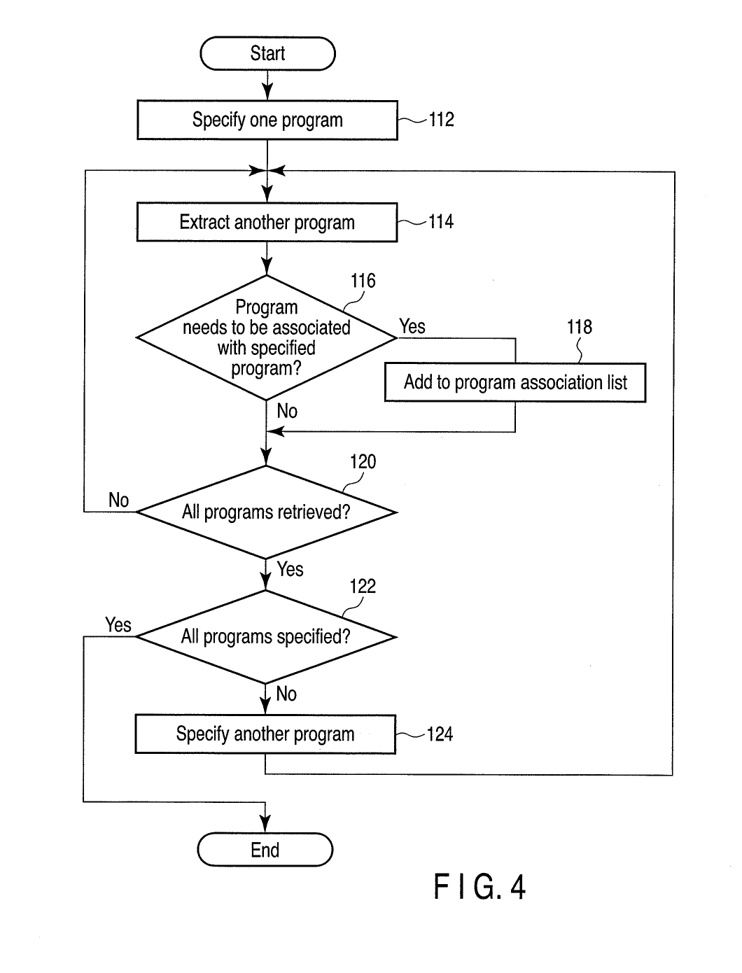

Block 102 is a process for discovering relevance between programs, and extracts a group of relevant programs based on program information stored in the program information recording module 18, such as programs of which program titles agree, a program whose title is included in program information of another program in an EPG, for example, or programs of the same genre. Details about block 102 will be described later with reference to FIG. 4.

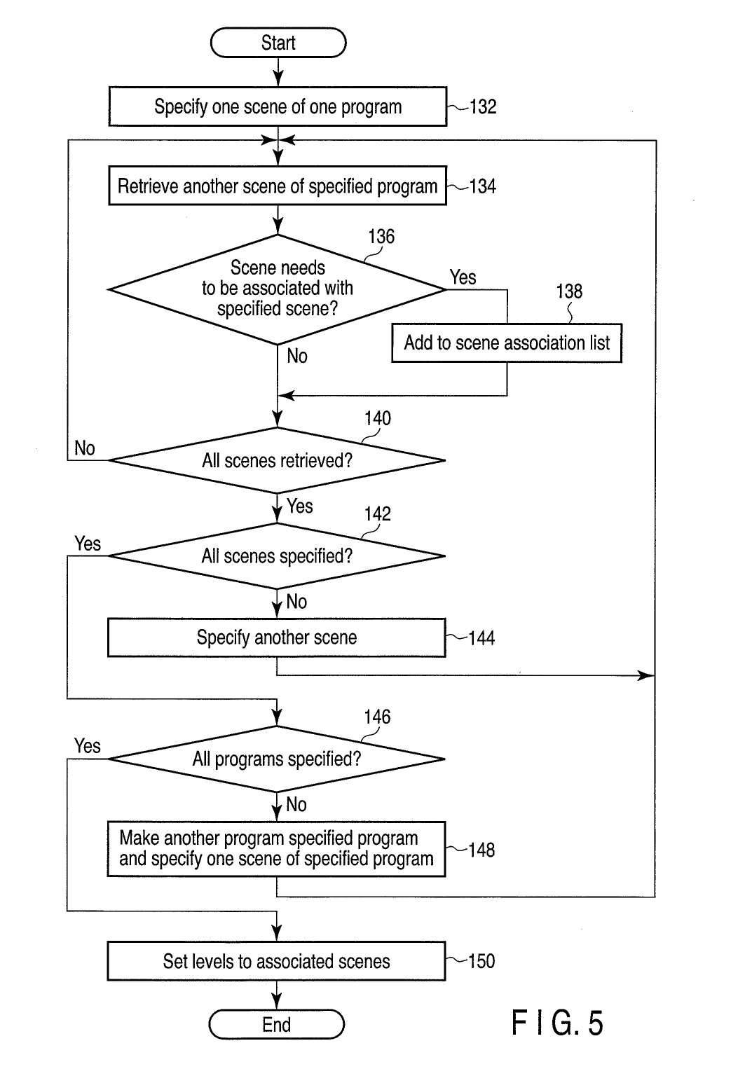

Block 104 performs a process of associating scenes with respect to the group of programs selected in block 102, and assigns priorities for playback among a group of relevant scenes. Details about block 104 will be described later with reference to FIG. 5.

Block 106 performs digest playback based on the priorities set in block 104. Details about block 106 will be described later with reference to FIG. 7.

FIG. 4 is a flowchart illustrating the process of block 102 of FIG. 3 in detail. The controller 12 specifies one program from the programs stored in the program recording module 16 in block 112. The controller 12 retrieves another program in block 114. In block 116, it is determined whether the retrieved program needs to be associated with the specified program. This determination is based on comparison of the degree of similarity of program information between two programs. It is determined, for example, that programs with the same program title or of the same genre need to be associated. When it is determined that the association is needed, the retrieved program is added to a program association list of the specified program in block 118.

It is determined in block 120 whether all the programs have been retrieved. When a program to be retrieved remains, the process returns to block 114 and another program is retrieved.

When all the programs have been retrieved, it is determined in block 122 whether all the programs stored in the program recording module 16 have been specified. When any programs to be specified remain, another program is specified in block 124, the process returns to block 114, and another program is retrieved.

In this way, relevant programs are listed with respect to all the programs recorded in the program recording module 16.

FIG. 5 is a flowchart illustrating a process of block 104 of FIG. 3 in detail. The controller 12 specifies a certain scene of a certain program included in programs recorded in the program recording module 16 in block 132. The controller 12 retrieves another scene of the specified program in block 134. It is determined in block 136 whether the retrieved scene needs to be associated with the specified scene. This determination is based on comparison of the degree of similarity of scene information between two scenes. It is determined, for example, that scenes with same program title, of the same genre, with the same characters, with the same case title (in the case of news) need to be associated. When it is determined that association is needed, the scene of the retrieved program is added to a scene associating list of the specified scene of the specified program in block 138.

It is determined in block 140 whether all the scenes in the specified program have been retrieved. When any scenes to be retrieved remain, the process returns to block 134, and another scene is retrieved.

When all the scenes in the specified program have been retrieved, it is determined in block 142 whether all the scenes in the specified program have been specified. When any scenes to be specified remain, another scene is specified in block 144, the process returns to block 134, and another scene is retrieved.

When all the scenes in a specified program are specified, it is determined in block 146 whether all the programs stored in the program recording module 16 have been specified. When any programs to be specified remain, another program is specified in block 148, a scene of the specified program is specified, the process returns to block 134, and another scene is retrieved.

In this way, relevant scenes are listed with respect to all the scenes recorded in the program recording module 16. Relevant scenes may be scenes in the same program as well as scenes of different programs.

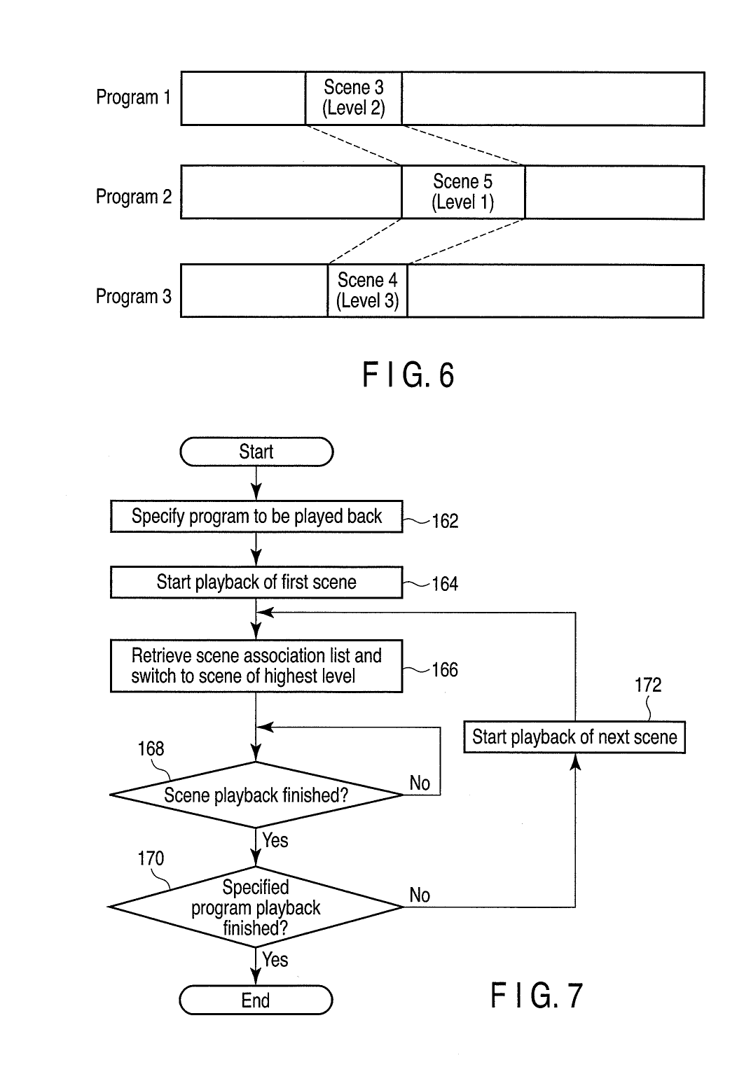

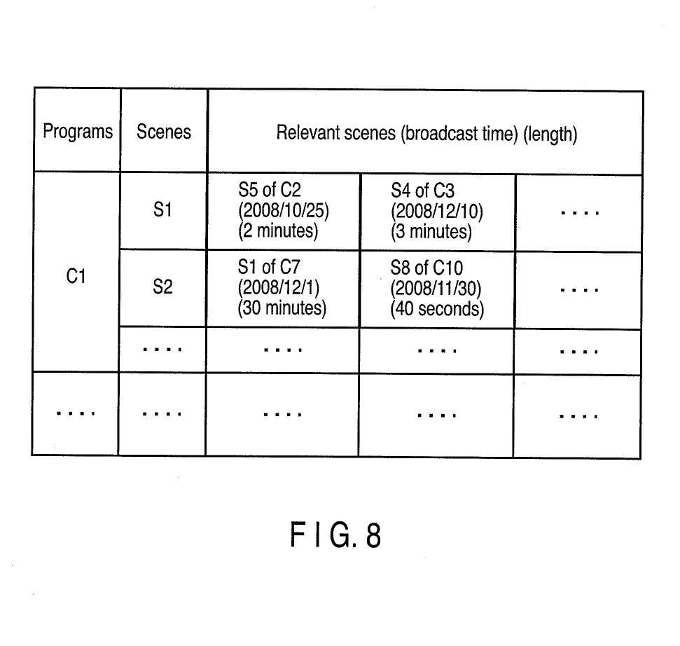

As the last step, in block 150, priorities for playback are assigned to the scenes in the group of relevant scenes listed in the scene association list. Priorities may be set based on broadcast time of the scene, or length of the scenes, for example. These may be combined as appropriate, or a predetermined one may be selected as priorities according to the genre of the program. In the case of a news program, for example, higher priorities may be assigned to the scene of the latest broadcast time or the longest scene among the relevant scenes. An example of priorities is shown in FIG. 6. Assume that Scene 3 of Program 1, Scene 5 of Program 2, and Scene 4 of Program 3 are associated, and that the priorities (assume that a higher priority is assigned to a lower level) are assigned such that Scene 3 of Program 1 is at Level 2, Scene 5 of Program 2 is at Level 1, and Scene 4 of Program 3 is at Level 3. FIG. 8 is an example of the scene association list to which information for priorities has been added. The scene association list describes relevant scenes, a broadcast time, and a length of each scene. For example, Scene S5 of Program C2 and Scene S4 of program 3 are associated with Scene S1 of Program C1, the broadcast time and the length of Scene S5 of Program C2 are Oct. 25, 2008, and 2 minutes, respectively, and the broadcast time and the length of Scene S4 of Program C3 are Dec. 10, 2008, and 3 minutes, respectively. Depending on the situation, one or both of the broadcast time and the length is used for priorities.

FIG. 7 is a flowchart illustrating digest playback of block 106 of FIG. 3 in detail. The controller 12 specifies a certain program in a program stored in the program recording module 16 in block 162. When playback of a first scene is to be started in block 164, the controller 12 examines a group of scenes relevant to the program with reference to a scene association list in block 166, and switches the playback to the scene with the highest priority among the group of scenes. For example, if playback of Scene S3 of Program C1 of FIG. 6 is to be started, since Scene S5 of Program C2 is at Level 1, which is the highest priority among the scenes relevant to Scene S3 of Program C1, which are Scene S5 of Program C2 and Scene S4 of Program C3, Scene S5 of Program C2 is played back, instead of Scene S3 of Program C1. There may be a case where the scene which has started to be played back in block 164 has the highest priority. In this case, this scene is played back. When finish of playback of the scene is detected in block 168, playback of the next scene of a specified program is to be started in block 164, the process returns to block 166, and the above-described operation is repeated.

Thereby, when playback of a certain program is instructed, a scene of another program relevant to each scene of the program, or a scene to which a higher priority is assigned among the scenes in the program is played back, and scenes with lower priorities are not played back. Therefore, similar scenes in a plurality of programs can be played back efficiently. A view flag may be provided for each item of scene information, such that if a scene to which the highest priority is assigned among the relevant scenes is viewed once, other relevant scenes with lower priorities will not be viewed. Alternatively, instead of prohibiting viewing, a playback speed may be increased.

As described above, according to the present embodiment, by dividing a series of scenes by configuration of frames or sound in a program, creating scene information as a summary of that scene, and examining similarity between the scene and scenes of another program based on the scene information, it is possible to examine association in units of scene. Therefore, by playing back a similar and more informative scene or another latest scene, instead of a certain scene, it is possible to view further details or refer to a compiled summary.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions. For example, in the above-described embodiment, when a certain program is viewed, playback is switched from each scene to a scene of another program with a higher priority. Therefore, the playback time is the same as the record time, that is, playback is performed at constant speed. However, usage of the scene information is not limited thereto, and may be modified in various ways. It is also possible to utilize scene information when all the scenes of a certain program are played back, instead of switching the scenes between programs. For example, when there is another scene relevant to each scene, the playback speed may be set high according to the low priority. When the scene with the highest priority is played back at a normal speed, the other scenes are played back at high speed, and all the programs are played back in the order of those scenes, the total playback time of all the programs is decreased.

What is claimed is:

1. A video playback apparatus comprising:
a program recorder configured to record programs each divided into scenes;
a program information recorder configured to record program information comprising scene information of each scene of a program recorded by the program recorder;
a priority setting module configured to examine relevance of scenes among the programs recorded by the program recorder based on the scene information recorded by the program information recorder in order to set priorities to relevant scenes among the programs recorded by the program recorder;
a playback instruction module configured to instruct playback of any one of the programs recorded by the program recorder; and
a playback module configured to play back a scene with a highest priority among scenes relevant to a certain scene of a program of which playback is instructed.

2. The apparatus of claim 1, wherein the priorities are based on a broadcast time of a scene, and a highest priority is set to a scene having a latest broadcast time.

3. The apparatus of claim 1, wherein the priorities are based on a length of a scene, and a highest priority is set to a longest scene.

4. The apparatus of claim 1, wherein the scene information comprises at least one of a program title, a genre name, characters, a case title, a broadcast time, and a length of a scene.

5. The apparatus of claim 1, further comprising:
a dividing module configured to divide a program into scenes based on change in video or sound of the program; and
a module configured to generate scene information comprising a text representing characteristics of an image and sound of a scene when a program is divided into the scenes.

6. A video playback method comprising:
recording programs each divided into scenes;
recording program information comprising scene information of each scene of a recorded program;
examining relevance of scenes among the recorded programs based on the recorded scene information in order to set priorities to relevant scenes among the recorded programs;
instructing playback of any one of the recorded programs; and
playing back a scene with a highest priority among scenes relevant to a certain scene of a program of which playback is instructed.

7. The method of claim 6, wherein the priorities are based on a broadcast time of a scene, and a highest priority is set to a scene having a latest broadcast time.

8. The method of claim 6, wherein the priorities are based on a length of a scene, and a highest priority is set to a longest scene.

9. The method of claim 6, wherein the scene information comprises at least one of a program title, a genre name, characters, a case title, a broadcast time, and a length of a scene.

10. The method of claim 6, further comprising:
dividing a program into scenes based on change in video or sound of the program; and
generating scene information comprising a text representing characteristics of an image and sound of a scene when a program is divided into the scenes.
